(19) United States
(12) Patent Application Publication
(10) Pub. No.: US 2020/0030961 A1
(43) Pub. Date: Jan. 30, 2020

(54) Rework system for unsoldering and/or soldering electronic components on a circuit board

(71) Applicant: ERSA GmbH, Wertheim (DE)

(72) Inventors: Udo Hofmann, Roellbach (DE); Sai-Krishna Vuppala, Wertheim (DE); Wolfram Sinn, Offenbach (DE); Benedict Schulz, Wertheim-Bettingen (DE)

(73) Assignee: ERSA GmbH, Wertheim (DE)

(21) Appl. No.: 16/522,738

(22) Filed: Jul. 26, 2019

(30) Foreign Application Priority Data
Jul. 26, 2018 (DE) 10 2018 118 103.5

(51) Int. Cl. B25H 1/02; B23K 37/04

(52) U.S. Cl. CPC B25H 1/02; B23K 37/0461

(57) ABSTRACT

Rework system for unsoldering and/or soldering electronic components on a circuit board, having a work table for fastening the circuit board, having a module which can travel along at least one X-axis and one Y-axis having at least one camera for accommodating electronic components provided on the circuit board, having a drive unit on which the module can travel with the camera, having a control unit for activating the drive unit, having a computing unit to which a display and user-operable input means are assigned, wherein the input means comprises a pointer which can be moved on the display and a command generator which can be operated in a positioning mode for positioning the camera in two steps (rough positioning and fine positioning).

### CROSS REFERENCE TO RELATED APPLICATIONS

This application relates and claims the priority to German Patent Application No. 10 2018 118 103.5 filed Jul. 26, 2018, the entire disclosures of which is incorporated herein by reference.

### BACKGROUND OF THE INVENTION

The invention relates to a rework system for unsoldering and/or soldering electronic components on a circuit board.

Missing or poor solder connections can occur during the population of circuit boards using electronic components. Moreover, electronic components can be completely missing, incorrectly placed, twisted or defective. Rework systems are used to eliminate these errors by unsoldering the individual components on the circuit board, replacing them if necessary and soldering them back together.

For the repair of larger circuit boards, rework systems can be used which have a work table for fastening the circuit board. Further, preferably at least one camera is present which captures the electronic components provided on the circuit board, which are then represented enlarged on a display. The camera can thereby travel freely along at least one X-axis and one Y-axis on the work table, in particular parallel to the fastened circuit board. Further, it is conceivable that the camera can travel upwards along a Z-axis perpendicular to the plane of the work table.

A drive unit is provided for the travel of the at least one camera. A control unit is used for the activation of the drive unit. Further, a computing unit is provided, for example in the shape of a computer, to which a display and user-operable input means are assigned. The input means comprises in particular a pointer that can be moved on the display, for example a mouse pointer, and a command generator, such as a switch or a button on a computer mouse or a touch pad.

Particularly when processing larger circuit boards, which can have a side length of 50 or more centimeters, it turns out that positioning the camera above the electronic components to be processed is comparatively difficult, since the enlargement of the components represented on the display is very high and since the positioning must also be accurate to 1/10 to 1/100 millimeter. In addition, if the camera is not above the circuit board, but above a heating element, for example, the orientation via the visual indicator alone is not possible.

Therefore, the object of the present invention is to provide a rework system described above, in which the camera is positioned in a comparatively simple manner.

### SUMMARY OF THE INVENTION

This object is solved by a rework system with a computing unit is configured in such a manner that in a positioning mode, control signals are generated by using the input means, in dependence on which the control unit activates the drive to position the camera. Thus, the input means and the computing unit are also used here for the activation of the drive unit, wherein the control unit which activates the drive can also form a part of the computing unit.

The computing unit is further configured in such a manner that in the positioning mode, on the display in a camera image area, the captured camera image, which is evaluated, edited and/or processed optionally by the computing unit, and which represents the circuit board and/or the electronic components of the circuit board is shown enlarged, and, in particular, next to or on the camera image area, an overview image showing the work table and/or a circuit board fastened to the work table is shown. Thereby, the overview image can be captured by an additional camera for example, which covers the entire work table with the circuit board. The overview image can also be a stored image or, for example, an image obtained from CAD data of the circuit board to be processed or a map representing the work table and/or the respective circuit board.

The camera image displayed on the display is preferably two-dimensional; however, it is also conceivable that the camera image generated by at least one camera is presented three-dimensionally. For a three-dimensional presentation it is advantageous if not only the data from one camera, but from two or a plurality of cameras are available and these are accordingly evaluated, edited and/or processed. Therewith a positioning of the camera, and if necessary additional assemblies, which can travel and which the rework system comprises, can take place in space.

Thus, the display shows, among other things, the camera image area showing the camera image and, independently of this, an overview image showing the work table or the circuit board.

Thereby, the pointer can be moved into the overview image and there to a first target position of the camera. The overview image, which gives an overview of the work table or the circuit board, is thus an orientation aid for the user, who moves the pointer in the overview image to the location where the camera should move to (target position).

If the command generator is then actuated, the drive unit is activated in such a manner that the camera travels to a first target setting corresponding to the first target position and that the camera image captured and, if necessary, edited in this target setting is displayed on the display. The camera thus travels to the respective target setting corresponding to the target position selected on the overview image. After reaching the target setting, the camera image is shown on the display in the target setting. By actuating the command generator at the first target position of the overview image, the camera thus can be roughly positioned; the camera moves into the area which the user selects “roughly” in the overview image.

After reaching the first target setting of the camera, the pointer, which can be freely moved in the camera image area displayed on the display, can be moved to a second target setting in the camera image. The user can thus select a second target position in the displayed camera image which he would like to view closely.

The user can also perform a second rough positioning by moving the pointer to another location in the overview image and actuating the command generator there. The camera then moves to this position.

If the user actuates the command generator at the second target position in the camera image area, the drive unit is activated in such a manner that the camera travels into a second target setting corresponding to the second target position, and that the camera image in this target setting is displayed on the display in a specific position in the camera image area. The specific position can in particular be a central or centered position. In this respect, a fine positioning of the camera can be easily achieved.

Thereby, the rough positioning and the fine positioning can be achieved independently of each other as often as desired.

Due to the rework system according to the invention, an exact and in particular central or centered positioning of the camera above the area of the circuit board can take place in only two steps, which area ultimately have to be viewed or processed. Further, it is advantageous that no other, additional input means are required for the camera to travel to the desired, second target setting.

Further, it is advantageous if the rework system or its computing unit is configured in such a manner that it is possible to switch from another mode to the positioning mode. Since the rework system according to the invention not only positions a camera but also heats specific electronic components, removes them from the circuit board and places them back on the circuit board, the computing unit can advantageously be operated in different modes, in particular in a positioning mode, in a warm-up mode, in a removal mode and/or in an insertion mode.

Further, it is advantageous if the computing unit is configured in the positioning mode in such a manner that the camera image in the first and/or second target setting is displayed centrally and in particular centered in the camera image area. The specific position in the camera image area is then a central or a centered position. This ensures that the user can easily find his way around and that he finds the desired target setting centrally on the display or in the area where the camera image is shown.

Moreover, it is advantageous if the computing unit in the positioning mode is configured in such a manner that the actual position corresponding to the respective current actual setting of the camera is displayed in the overview image. This is particularly advantageous while the camera is traveling. As a result, the user can easily see that the camera is traveling and can keep track of where the camera is located relative to the circuit board or the work table.

According to the invention, it is also conceivable that the computing unit in the positioning mode is configured in such a manner that when the camera is traveling, the camera image captured during the traveling is displayed on the display. Hereby, the user also receives feedback that the camera travels and sees the image of the circuit board captured by the camera and displayed enlarged on the display.

Further, it is conceivable that the computing unit in the positioning mode is configured in such a manner that, when the pointer is in the camera image area or in the overview image during the traveling of the camera and when the command generator is additionally actuated, the drive unit is activated in such a manner that the travel movement is stopped. Hereby, the user has the possibility to stop the travel movement at any time by actuating the command generator. This can be particularly useful if the user sees a different area of the circuit board which he wants to view in detail while the camera is traveling.

The computing unit is preferably configured in the positioning mode in such a manner that the ratio of the displayed camera image to the displayed overview image is in the area of 40:3 to 40:1 and in addition in the area of 40:2. Thereby, it is conceivable that the camera image area occupies the largest part of the display and that the overview image is only about 20 times smaller than the camera image area represented in the display area.

In addition, it is advantageous if the computing unit in the positioning mode is configured in such a manner that a zoom function of the camera image is provided and that the zoom function can be actuated by means of the pointer and/or by actuation of the command generator. The zoom function can be represented on the display, for example in or next to the camera image area and/or in or next to the overview image.

Further, it appears advantageous when the calculating unit in the positioning mode is configured in such a manner that when the pointer is in the area of the overview image, it has a different contour than when the pointer is located in the camera image area. Hereby, it can be visualized to the user that a different function is assigned to the pointer in the camera image area than in the overview image. Thereby, it can be advantageously provided that the computing unit is configured in such a manner that the contour of the pointer can be selected by the user. In particular, it is possible to select which contour in which area is displayed on the display in the respective phase.

In particular, it has proven to be advantageous if the contour of the pointer is presented as a rectangle in the overview image. The size of the rectangle is thereby particularly proportional to the size of the camera image provided by the camera. If the camera enlarges the image, the rectangle in the overview image is comparatively small; if the enlargement is low, the rectangle is comparatively large.

Further, it is conceivable that the overview image is divided into grid squares. The user can select a position within the grid squares, between the grid squares or even a grid square comparatively quickly using the rectangular pointer and press the command generator so that the camera travels to the first target setting.

The division of the grid squares can correspond to an arrangement of heating elements provided on the work table.

For additional increase of functionality, it is advantageous if the computing unit is configured in the positioning mode in such a manner that the overview image can be shifted and/or minimized and/or maximized by means of the pointer and/or by actuation of the pointer on the display. The overview image can thus be moved freely on the display and shifted where it does not interfere with the user's perception of the display. In particular, it is conceivable that the overview image can be shifted into one of the corners of the screen. Moreover, it is possible that the overview image is also displayed on the display in a transparent or partially transparent manner.

Furthermore, it is advantageous if the computing unit is configured in such a manner that it forms a first module which represents the overview image on the display and that it forms a second module which represents the camera image area on the display, wherein both modules can be made available or are made available independently of one another. As a result, the two modules are independent, which increases the safety of the rework system in the positioning mode. A failure or an error present in one module does not directly affect the other module. The communication between the two modules can be made available by the computing unit.

### BRIEF DESCRIPTION OF THE DRAWINGS

Additional details and advantageous designs of the invention can be found in the following description, which describes and explains an exemplary design of the invention in more detail.

In which:

FIG. 1 is a rework system according to the invention;

FIG. 2 is the display of the rework system according to FIG. 1 in the positioning mode in a first state;

FIG. 3 is the enlarged map shown in FIG. 2;

FIG. 4 is the display according to FIG. 2 in an additional state;

FIG. 5 is the display according to FIG. 4 when selecting the target position;

FIG. 6 is the display according to FIG. 5 when actuating the target position;

FIG. 7 is the display according to FIG. 6 when the camera is traveling;

FIG. 8 is the display according to FIG. 7 when reaching the target setting of the camera;

FIG. 9 is the display according to FIG. 8 when moving the pointer;

FIG. 10 is the display according to FIG. 9 when moving the pointer to the second target position, and

FIG. 11 is the display according to FIG. 10 of the second target setting.

### DETAILED DESCRIPTION

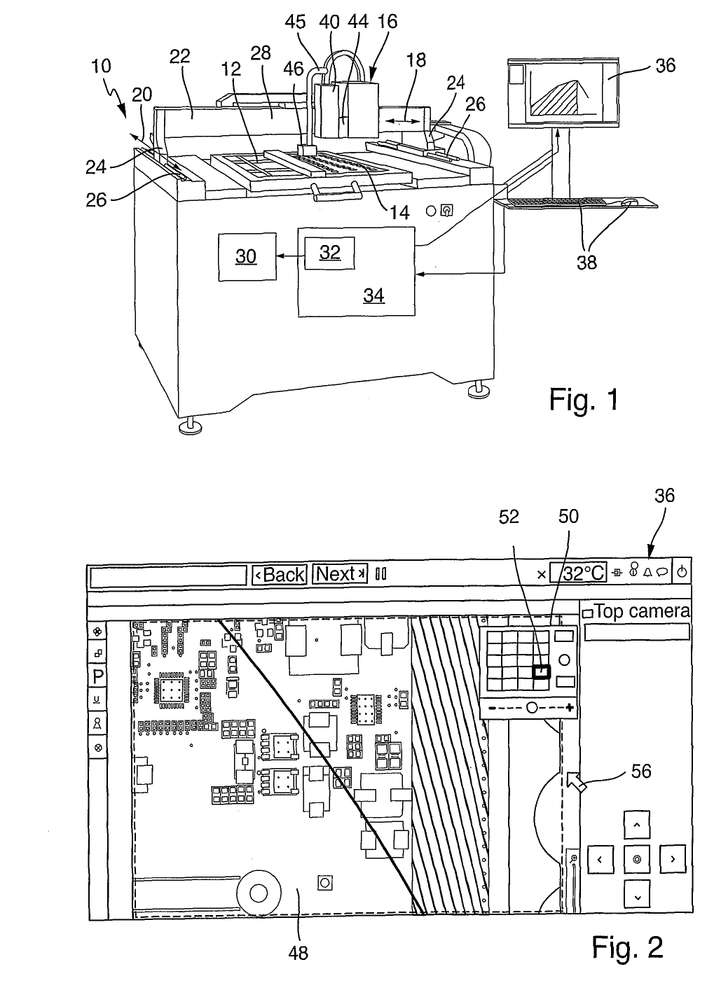

FIG. 1 shows a rework system 10 for unsoldering and/or soldering electronic components on a circuit board 14. The rework system 10 comprises a work table 12 on which a circuit board 14 is clamped. A processing module 16 is arranged above the table 12 or the circuit board 14, which can travel along an X-axis 18 and a Y-axis 20. The module 16 can also travel in a vertical direction along a Z-axis. A portal-shaped carrier 22 that has two supports 24 at its free ends is provided for the traveling of the module 16. The supports 24 can thereby travel along the Y-axis 20 in associated guides 26. An additional guide 28 is provided on the carrier 22, along which the module can travel in the X-direction 18, i.e. perpendicular to the Y-direction 20. A drive unit 30 which is not described in more detail in FIG. 1 is provided for the traveling of the module 16 in space. The drive unit 30 can comprise servo motors that travel the carrier 22, and therewith the module 16, in the X-direction, the module 16 on the carrier 22 in the Y-direction and the module 16 in the vertical Z-direction. A control unit 32 is provided to activate the drive unit 30. Further, a computing unit 34 is provided, wherein the control unit 32 is a component part of the computing unit 34 or is formed by it or integrated into it. In a not shown embodiment the control unit can also form a distinct unit, separated from the computing unit 34.

A display 36 is assigned to the computing unit 34, as well as input means 38, which can be operated by a user and which, in the embodiment shown, contains a keyboard and a computer mouse with a mouse pointer on the display 36. The input means 38 can also be designed differently, for example as a touchpad or touch-sensitive display (touch screen).

The module 16 of the embodiment shown comprises a heating device 40 to heat 14 electronic components present on the circuit board or their solder connections with the circuit board. The module 16 also comprises an automated gripping device 42, used to lift electronic components from the circuit board 14 and place them precisely on the circuit board 14. Further, a top camera 44 (hereinafter referred to as camera) is installed in the module 16, which is used to receive the circuit board 14 or the components arranged thereon from above. Additionally to the camera 44, an RPC camera 46 (Reflow Process Camera) is provided at the module 16 via an arm 45, with which the electronic components can be captured obliquely from the front and in particular the fusing of the solder can be observed.

The heating device 40 and the gripping device 42 as well as the camera 44 and the additional camera 46 can be activated via the computing unit 34 or via additional control units.

For positioning the module 16 above the circuit board 14, the module 16 together with the camera 44 travels via a suitable activation of the drive unit 30 in such a manner that the respective electronic part on the circuit board 14 is located precisely below the module 16. This is not easily possible with larger circuit boards, which can have a length and a width of several 10 centimeters, since the image captured by the camera 44 is also shown highly enlarged on the display 36.

For the positioning of the module 16 or the camera 44 above the desired part, the computing unit 34 is first switched into a positioning mode via the input means 38.

In this positioning mode, the display 36 shows the image shown in FIG. 2. The display 36 shows firstly the camera image of the camera 44 in a camera image area 48. In the camera image area 48 the circuit board 14 is to be seen highly enlarged with the electronic components arranged on it.

The camera image represented on the display 36 is preferably two-dimensional; however, it is also conceivable that the images captured by the two cameras 44 and 46 are evaluated, edited and processed by the computing unit 34 in such a manner that a three-dimensional camera image is presented in the camera image area 48. Therewith, a positioning of the camera 44 and the entire module 16 with the corresponding components can take place in the space above the circuit board 14. If it is mentioned in the following that the “captured” camera image is “shown” in the camera image area 48, this may also comprise the evaluating, editing and processing of the image data generated by the camera 44 and possibly also by the camera 46 and made available to the computing unit 34.

At the top right, the display 36 shows an overview image in the shape of a map 50, which represents the surface of the work table 12 reduced in size. The map was generated from an illustration of stored CAD data defining the circuit board. Instead of a map 50 it would be also conceivable to fade in a camera image as overview image, which is captured by a camera, which covers the entire work table and/or the entire circuit board 14 to be processed.

The map 50 shows the work table 12 divided into 20 grid squares. Depending on the size and design of the work table 12, a different number and division of grid squares may be provided, in particular 5×5 grid squares, i.e. a total of 25 grid squares. The size and alignment of the grid squares can correspond to the heating elements present in the working space with which the circuit board 14 can be heated.

Further, the actual position of the camera 44 on the map 50 is marked by highlighting a rectangle 52. The section shown by the camera 44 does not necessarily have to correspond to the size of a grid square.

Altogether, when viewing the map 50, the user has an immediate impression of which area of the circuit board 14 is visible in the camera image area 48 on the display 36.

On the display 36 according to FIG. 2, additional information can be made available, for example various menus that can be selected to change modes, as well as other technical information.

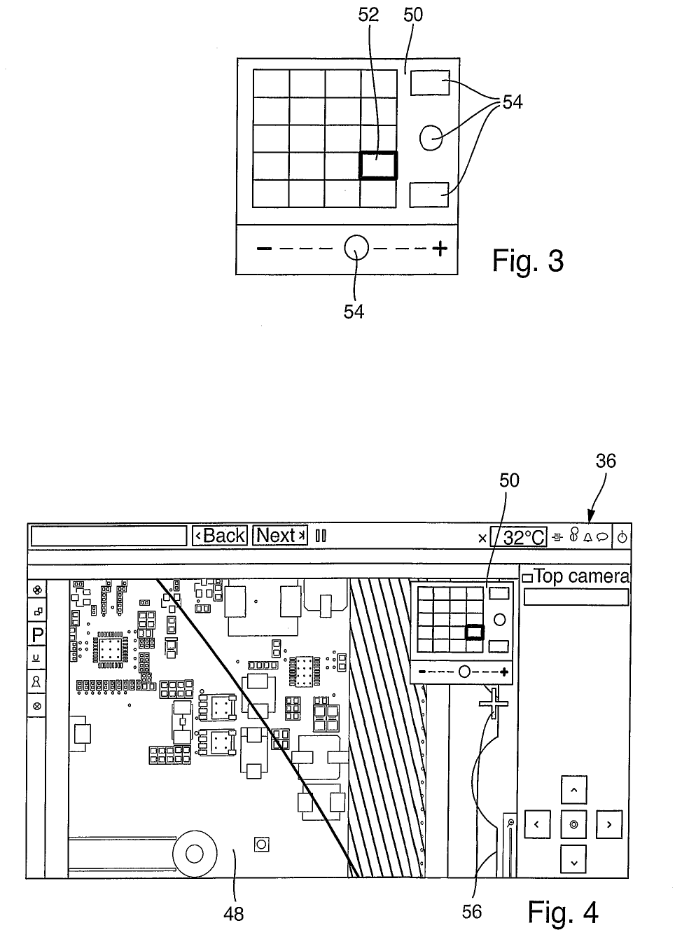

The map 50 is shown enlarged in FIG. 3. Clearly recognizable are single grid squares, into which the table 12 is divided as well as the area or the rectangle 52 of the table 12 or the circuit board 14, which is currently captured by the camera 44. The highlighted area 52 thus corresponds to the actual position of the camera 44. The map 50 can have additional pushbuttons 54, for example to minimize the map 50 or to maximize the map 50, or to zoom into the map 50 or to make the map 50 transparent.

In order for the module 16 and the camera 44 to travel into a certain position in the positioning mode in a comparatively simple and yet precise manner, the computing unit 34 is configured in such a manner that it can be operated as explained below.

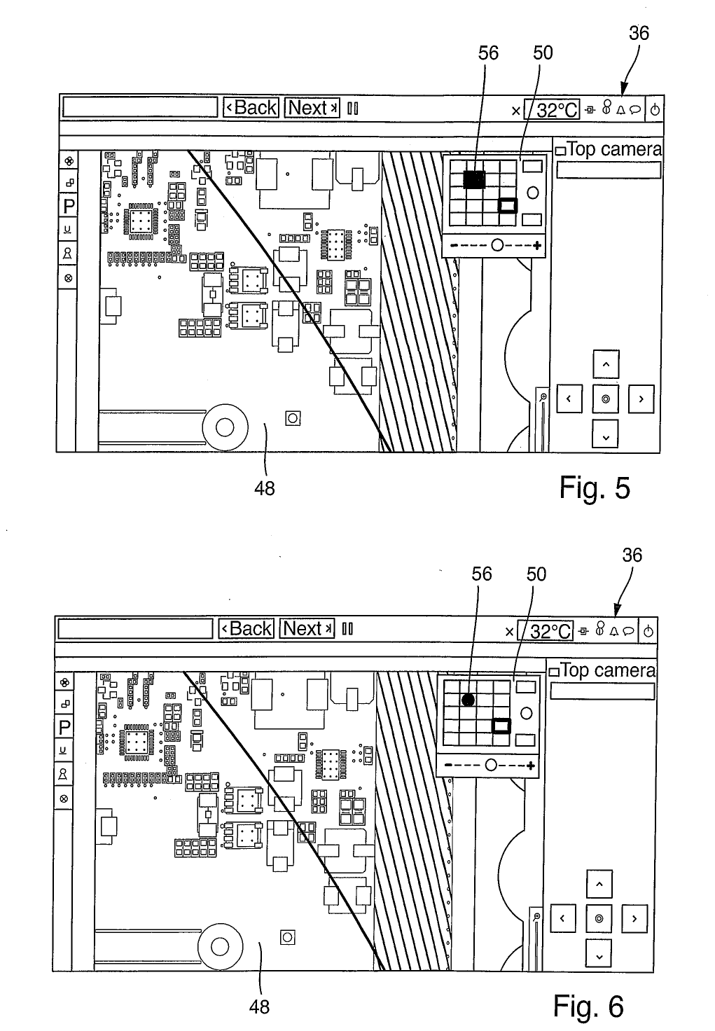

By means of the input means 38, and particularly with a mouse, a pointer 56 shown in FIG. 2 can be moved on the display 36. The computing unit 34 is thus set up in such a manner that when the pointer 56 is moved in or out of the camera image area 48, the pointer 56 changes its contour. In FIG. 4, the pointer 56 is located within the camera image area 48 and is represented there as a cross. If the pointer 56 is then moved additionally into the area of the map 50, as represented in FIG. 5, then the pointer 56 changes its contour again. In FIG. 5, the pointer 56 is represented as a filled rectangle, which corresponds to the ratio of the size of the camera image to be displayed in the camera image area 48.

The computing unit 34 is additionally configured in the positioning mode in such a manner that the pointer 56 on the map 50 can be used to select a target position which the camera 44 should travel to. Selecting the target position is achieved by actuating a command generator on the input means 28, for example by single or double-clicking the mouse button.

If in FIG. 5 the position selected using the pointer 56 in the map 50 is confirmed by clicking on it, then the pointer 56 changes its contour again, as shown in FIG. 6. The pointer 56 is represented there as a circle after selecting the target position and actuating the command generator.

The starting position and the destination position of the camera 44 are thus represented as a rectangle on the map 50, where the destination position is represented by the position of the pointer 56. After triggering the travel of the camera 44, the shape of the pointer changes to a preferably red circle, in which a white square is preferably present. This symbol, which is inspired by the stop button of a recording device, is intended to indicate that an additional command input, i.e. a click, interrupts the travel movement during the travel. While in particular this red circle with the white square is displayed, no other command input is possible than to abort the travel movement. This will make a protection mechanism available which saves the user from having to search for a shutdown button.

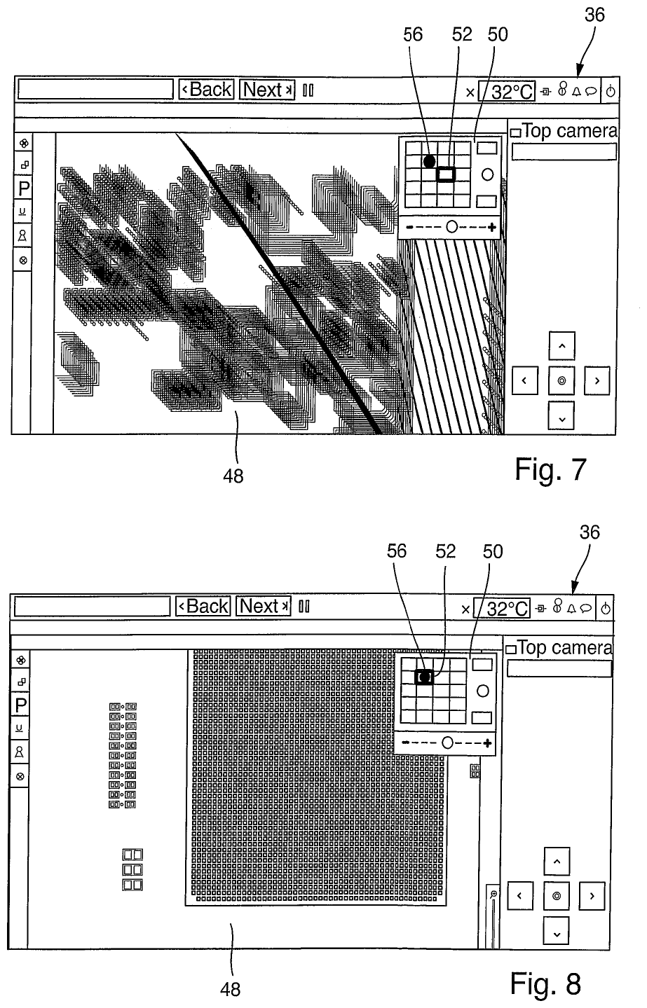

By actuating the command generator, the drive unit 30 is activated by the control unit 32 or by the computing unit 34 in such a manner that the module 16, and thus the camera 44, travels in the direction of an actual target setting corresponding to the target position for rough positioning. During the travel, the camera image captured by the camera 44 is displayed in the camera image area 48 of the display 36, which is unclear or blurred due to the comparatively fast travel of the camera 44 in FIG. 7.

Due to the movement of the camera 44, the actual position 52 of the camera 44 displayed on the map 50 also changes. As a result, the user also has an overview of where the camera 44 is located on the map 50 or which portion of the circuit board 14 is reproduced in the camera image area 48 when moving the camera 44.

By reaching the target setting of the camera 44, the actual position 52 represented on the map 50 reaches the target position selected on the map 50; in FIG. 8, the bordered rectangle surrounds the selected first target position, i.e. the actual position 52, which was clicked by the pointer 56. The associated section of the circuit board 14 is now represented in the camera image area 48.

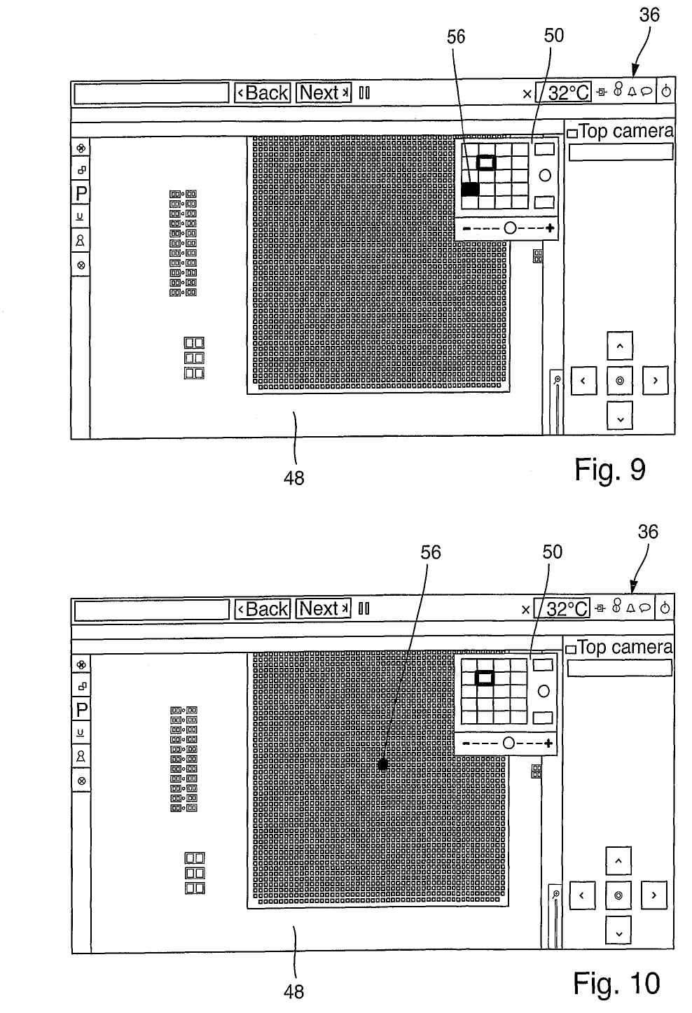

The computing unit 34 is furthermore configured in such a manner that, for example, the pointer 56 can be moved from the map 50 to the camera image area 48 after reaching the first target setting of the camera 44, as shown in FIG. 8. If the pointer 56 is moved over the map 50, it changes its contour again to a filled rectangle, as shown in FIG. 9. If the pointer 56 is now dragged additionally from the map 50 into the camera image area 48, then the pointer 56 changes its contour again; it changes again to the circular contour, as shown in FIG. 10. As a result, the user is signaled that he can now perform the fine positioning by placing the pointer 56 in the camera image area 48 at the position he wants to center in the camera image area 48.

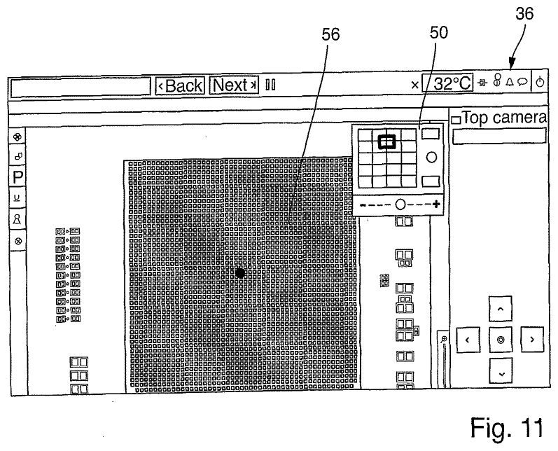

If the user now moves the pointer 56 in FIG. 10 to the second target position and actuates the command generator there, the drive unit 30 is activated in such a manner that the camera 44 travels to a second target setting corresponding to the second target position for fine positioning. After triggering the travel of the camera 44, the shape of the pointer 56 changes again into a red circle, in which preferably a white square is present, which is inspired by a stop button of a recording device. The camera image captured by the camera 44 in the second target setting is then, as shown in FIG. 11, centered in the camera image area 48.

The computing unit 34 is configured in the positioning mode in such a manner that when, during the travel of the camera 44, the pointer 56 (which is then in particular presented as a red circle with a white square within it) is in the camera image area 48 or in the map 50, and when the command generator is additionally actuated, the drive unit 30 is activated in such a manner that the travel movement is stopped. Hereby, the user has the possibility to stop the travel movement at any time by actuating the command generator.

Thereby, the camera image is adapted to the movement of the camera 44 or to the motor or the travel steps of the drive unit 30 and the system is calibrated in μm area so that length or distance measurements can be made.

By actuating the corresponding pushbuttons, the camera image shown in the camera image area 48 can be additionally enlarged or reduced if necessary.

With the described setup of the computing unit, the camera can travel to the desired target setting in a comparatively simple and fast manner in order to inspect the desired electronic component.

Advantageously, the computing unit 34 has two independent modules, one module indicating the respective camera image in the camera image area 48 and another module indicating the map 50 and the respective actual position 52 of the camera in the map 50. The computing unit 34 can thereby provide the two modules with identical parameters, so that the two modules synchronously represent the camera image in the camera image area 48 and the map 50 on the display 36.

1. Rework system for unsoldering and/or soldering electronic components on a circuit board, comprising:
a work table for fastening the circuit board,
a module which can travel along at least one X-axis and one Y-axis having at least one camera for accommodating electronic components provided on the circuit board,
a drive unit for moving the module with the camera,
a control unit for activating the drive unit,
a computing unit to which a display and user-operable input means are assigned, wherein the input means comprises a pointer which can be moved on the display and a command generator,
characterized in that the computing unit is configured in such a manner that in a positioning mode control signals are generated by using the input means, depending on which the control unit activates the drive unit for positioning the module and therefore the at least one camera, and
in that the computing unit is further configured in such a manner that in the positioning mode on the display in a camera image area the camera image of the at least one camera, which shows at least one of the circuit board and the electronic components of the circuit board enlarged, and an overview image showing at least one of the work table and a circuit board fastened to the work table,
wherein, the pointer can be moved into the overview image and there to a first target position of the camera,
and upon actuating the command generator, when the pointer at the first target position is in the overview image, the drive unit is activated in such a manner that the camera travels into a first target setting corresponding to the first target position, and that, in this target setting, the camera image is displayed on the display in the camera image area,
and after the camera has reached its first target setting, the pointer can be moved in the camera image area displayed on the display to a second target position displayed in the camera image, and
upon actuating the command generator, when the pointer is in the camera image area at the second target position, the drive unit is actuated in such a manner that the camera travels to a second target setting corresponding to the second target position, and that, in this second target setting, the camera image is displayed on the display in a specific position in the camera image area.

2. Rework system according to claim 1, characterized in that the computing unit is configured in such a manner that it is possible to switch from another mode into the positioning mode.

3. Rework system according to claim 1, characterized in that the computing unit is configured in the positioning mode in such a manner that the camera image in at least one of the first and second target settings is displayed centrally and in particular centered in the camera image area.

4. Rework system according to claim 1, characterized in that the computing unit is configured in the positioning mode in such a manner that an actual position corresponding to the respective current actual setting of the camera is displayed in the overview image.

5. Rework system according to claim 1, characterized in that the computing unit is configured in the positioning mode in such a manner that the camera image, when the camera travels, is displayed on the display during the travel.

6. Rework system according to claim 1, characterized in that the computing unit is configured in the positioning mode in such a manner that, when, during the travel of the camera, the pointer is in the camera image area or in the overview image and when the command generator is additionally actuated, the drive unit is activated in such a manner that the travel movement is stopped.

7. Rework system according to claim 1, characterized in that the computing unit is configured in the positioning mode in such a manner that the ratio of the camera image area to the displayed overview image is in the area from 40/3 to 40/1.

8. Rework system according to claim 1, characterized in that the computing unit is configured in the positioning mode in such a manner that a zoom function of the camera image is made available, and in that the zoom function can be actuated by means of at least one of the pointer and actuation of the command generator.

9. Rework system according to claim 1, characterized in that the computing unit is configured in the positioning mode in such a manner that the pointer has a different contour when it is located in the area of the overview image than when the pointer is located in the camera image area.

10. Rework system according to claim 1, characterized in that the contour of the pointer in the overview image is formed as a rectangle.

11. Rework system according to claim 1, characterized in that the computing unit is configured in the positioning mode in such a manner that the overview image can be at least one of displaced, minimized, and maximized on the display by means of at least one of the pointer and actuation of the command generator.

12. Rework system according to claim 1, characterized in that the computing unit is configured in such a manner that it forms a first module which represents the overview image on the display, and in that it forms a second module which represents the camera image area on the display, wherein both modules can be made available or are made available independently of one another.
